(19) United States
(12) Patent Application Publication
(10) Pub. No.: US 2025/0189326 A1
(43) Pub. Date: Jun. 12, 2025

(54) ROUTE COMPUTATION APPARATUS, ROUTE COMPUTATION METHOD, AND NON-TRANSITORY STORAGE MEDIUM

(71) Applicant: NEC Corporation, Minato-ku, Tokyo (JP)

(72) Inventors: Tingting DONG, Tokyo (JP); Jianquan LIU, Tokyo (JP); Noboru YOSHIDA, Tokyo (JP); Ryo KAWAI, Tokyo (JP); Satoshi YAMAZAKI, Tokyo (JP); Yuta NAMIKI, Tokyo (JP); Naoki SHINDOU, Tokyo (JP); Karen STEPHEN, Tokyo (JP); Youhei SASAKI, Tokyo (JP)

(73) Assignee: NEC Corporation, Minato-ku, Tokyo (JP)

(21) Appl. No.: 18/842,917

(22) PCT Filed: Mar. 16, 2022
(86) PCT No.: PCT/JP2022/011888

§ 371 Date: Aug. 30, 2024

(51) Int. Cl. G01C 21/34; G06V 20/52

(52) U.S. Cl. CPC G01C 21/3484; G06V 20/52

(57) ABSTRACT

A route computation apparatus (10) of the present invention includes: an acquisition unit (11) that acquires an image photographed by a camera installed at each of a plurality of observation points on a passageway; a determination unit (12) that determines an attribute of a passerby included in the image; a trend computation unit (13) that computes, based on a determination result on the attribute, a trend of an attribute of a passerby passing each of a plurality of the observation points; and a route computation unit (14) that computes, based on the trend, a traffic route suitable for a passerby with the predetermined attribute.

### TECHNICAL FIELD

The present invention relates to a route computation apparatus, a route computation method, and a storage medium.

### BACKGROUND ART

A technique related to the present invention is disclosed in Patent Documents 1 to 4, and Non-Patent Document 1.

Patent Document 1 discloses a technique in which a barrier condition serving as a criterion for passable/non-passable is extracted based on a behavior history of a wheelchair user, and a recommended route for the wheelchair user is computed based on the barrier condition. Data on a behavior history are constituted of image capturing data on a barrier photographed by a wheelchair user, and position information in which the barrier is present. A barrier is unevenness of a road surface, a step, and the like.

Patent Document 2 discloses a technique in which how a user feels a plurality of targets/events such as a place where many people gather, or a place where noisy people are present is registered, a site where the above-described plurality of targets/events have taken place is extracted by analyzing a real-time image, and a route to be presented to the user is computed based on an extraction result.

Patent Document 3 discloses a technique in which an evacuation route is searched for, while taking into consideration a disaster area or a status of a victim.

Patent Document 4 discloses a technique in which a feature value of each of a plurality of keypoints of a human body included in an image is computed, an image including a human body whose pose is similar or a human body whose motion is similar is searched for based on the computed feature value, and human bodies whose pose or motion is similar to each other are classified together.

Non-Patent Document 1 discloses a technique related to skeleton estimation of a person.

### RELATED DOCUMENT

### Patent Document

Patent Document 1: Japanese Patent Application Publication No. 2019-124587
Patent Document 2: Japanese Patent Application Publication No. 2017-181353
Patent Document 3: Japanese Patent Application Publication No. 2015-129658
Patent Document 4: International Patent Publication No. WO2021/084677

### Non-Patent Document

Non-Patent Document 1: Zhe Cao, Tomas Simon, Shih-En Wei, Yaser Sheikh, “Realtime Multi-Person 2D Pose Estimation using Part Affinity Fields”, The IEEE Conference on Computer Vision and Pattern Recognition (CVPR), 2017, P. 7291-7299

### DISCLOSURE OF THE INVENTION

### Technical Problem

A technique in which, instead of simply computing a shortest traffic route, a traffic route suitable for a person with various attributes, for example, a safe traffic route suitable for a woman, a traffic route suitable for a traveling person using a crutch, a traffic route suitable for a person walking while pulling a suitcase, and the like are computed has been desired.

The technique disclosed in Patent Document 1 can compute a traffic route suitable for a wheelchair user, but cannot compute a traffic route suitable for a person with another attribute.

The technique disclosed in Patent Document 2 extracts a site where a plurality of targets/events have taken place currently by analyzing an image. In a case of this technique, it is necessary to analyze, in real time, an enormous amount of images in which various sites are photographed. Consequently, processing load of a computer increases.

The technique disclosed in Patent Document 3 can compute a traffic route suitable for an evacuating person, but cannot compute a traffic route suitable for a person with another attribute.

Patent Document 4 and Non-Patent Document 1 are a technique for estimating a pose or a motion of a person, and are not a technique for computing a traffic route.

One example of an object of the present invention is, in view of the above-described problem, to provide a route computation apparatus, a route computation method, and a storage medium that solve a task of computing a traffic route suitable for a person with various attributes.

### Solution to Problem

One aspect of the present invention provides a route computation apparatus including:
an acquisition unit that acquires an image photographed by a camera installed at each of a plurality of observation points on a passageway;
a determination unit that determines an attribute of a passerby included in the image;
a trend computation unit that computes, based on a determination result on the attribute, a trend of an attribute of a passerby passing each of a plurality of the observation points; and
a route computation unit that computes, based on the trend, a traffic route suitable for a passerby with the predetermined attribute.

One aspect of the present invention provides a route computation method including,
by a computer:
   acquiring an image photographed by a camera installed at each of a plurality of observation points on a passageway;
   determining an attribute of a passerby included in the image;
   computing, based on a determination result on the attribute, a trend of an attribute of a passerby passing each of a plurality of the observation points; and
   computing, based on the trend, a traffic route suitable for a passerby with the predetermined attribute.

One aspect of the present invention provides a storage medium storing a program causing a computer to function as:
an acquisition unit that acquires an image photographed by a camera installed at each of a plurality of observation points on a passageway;
a determination unit that determines an attribute of a passerby included in the image;
a trend computation unit that computes, based on a determination result on the attribute, a trend of an attribute of a passerby passing each of a plurality of the observation points; and
a route computation unit that computes, based on the trend, a traffic route suitable for a passerby with the predetermined attribute.

### Advantageous Effects of Invention

According to one aspect of the present invention, a route computation apparatus, a route computation method, and storage medium that solve a task of computing a traffic route suitable for a person with various attributes are achieved.

### BRIEF DESCRIPTION OF THE DRAWINGS

The above-described object, the other objects, features, and advantages will become more apparent from public example embodiments described below and the following accompanying drawings.

FIG. 1 It is a diagram illustrating one example of a functional block diagram of a route computation apparatus.

FIG. 2 It is a diagram illustrating one example of a hardware configuration of the route computation apparatus.

FIG. 3 It is a diagram for describing processing of a determination unit.

FIG. 4 It is a diagram schematically illustrating one example of information to be processed by the route computation apparatus.

FIG. 5 It is a diagram illustrating one example of information to be output by the route computation apparatus.

FIG. 6 It is a flowchart illustrating one example of a flow of processing of the route computation apparatus.

FIG. 7 It is a flowchart illustrating another example of a flow of processing of the route computation apparatus.

FIG. 8 It is a diagram schematically illustrating one example of information to be processed by the route computation apparatus.

FIG. 9 It is a diagram illustrating one example of a functional block diagram of the route computation apparatus.

FIG. 10 It is a diagram schematically illustrating one example of information to be output from an output apparatus by the route computation apparatus.

### EXAMPLE EMBODIMENT

Hereinafter, example embodiments according to the present invention are described by using the drawings. Note that, in all drawings, a similar constituent element is indicated by a similar reference sign, and description thereof is omitted as necessary.

### First Example Embodiment

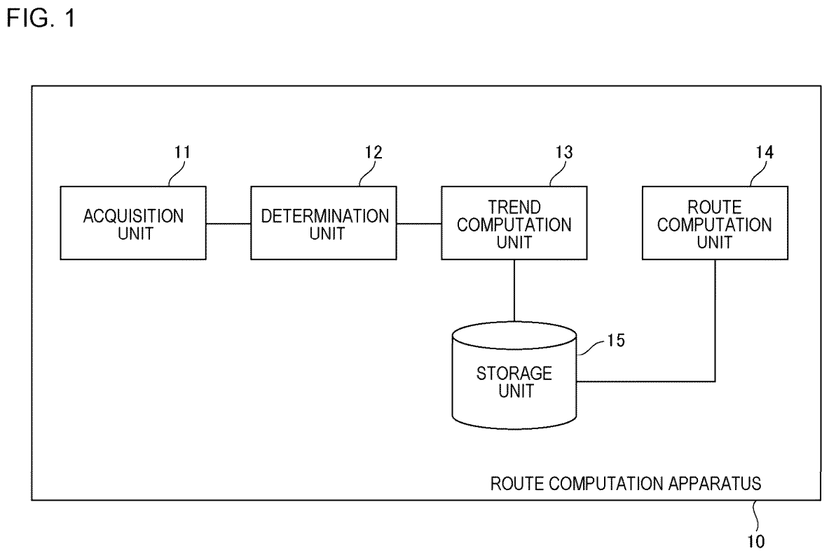

FIG. 1 is a functional block diagram illustrating an overview of a route computation apparatus 10 according to a first example embodiment. The route computation apparatus 10 includes an acquisition unit 11, a determination unit 12, a trend computation unit 13, a route computation unit 14, and a storage unit 15. Note that, the route computation apparatus 10 may not include the storage unit 15. In this case, an external apparatus configured to be communicable with the route computation apparatus 10 includes the storage unit 15.

The acquisition unit 11 acquires an image photographed by a camera installed at each of a plurality of observation points on a passageway. The determination unit 12 determines an attribute of a passerby included in the image. The trend computation unit 13 computes, based on a determination result on the attribute by the determination unit 12, a trend of an attribute of a passerby passing each of a plurality of the observation points, and causes the storage unit 15 to store the trend. The route computation unit 14 computes, based on a trend of an attribute of a passerby passing each of a plurality of the observation points, a traffic route suitable for a passerby with the predetermined attribute.

According to the route computation apparatus 10 with a configuration as described above, a task of computing a traffic route suitable for a person with various attributes is solved.

### Second Example Embodiment

### “Overview”

A route computation apparatus 10 according to a second example embodiment is an example embodiment in which the route computation apparatus 10 according to the first example embodiment is more specified. The route computation apparatus 10 analyzes an image photographed by a camera installed at each of a plurality of observation points on a passageway, and computes a trend of an attribute of a passerby passing each of a plurality of the observation points. Then, the route computation apparatus 10 computes, as a traffic route suitable for a passerby with each attribute, a traffic route including an observation point where a passerby with each attribute frequently passes, and not including an observation point where a passerby with each attribute does not pass, or seldom passes. Hereinafter, details are described.

### “Hardware Configuration”

Next, one example of a hardware configuration of the route computation apparatus 10 is described. Each functional unit of the route computation apparatus 10 is achieved by any combination of hardware and software, mainly including a central processing unit (CPU) of any computer, a memory, a program loaded in a memory, a storage unit (capable of storing, in addition to a program stored in advance at a shipping stage of an apparatus, a program downloaded from a storage medium such as a compact disc (CD), a server on the Internet, and the like) such as a hard disk storing the program, and an interface for network connection. Further, it is understood by a person skilled in the art that there are various modification examples as a method and an apparatus for achieving the configuration.

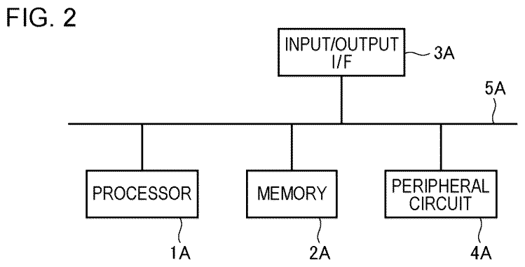

FIG. 2 is a block diagram illustrating a hardware configuration of the route computation apparatus 10. As illustrated in FIG. 2, the route computation apparatus 10 includes a processor 1A, a memory 2A, an input/output interface 3A, a peripheral circuit 4A, and a bus 5A. The peripheral circuit 4A includes various modules. The route computation apparatus 10 may not include the peripheral circuit 4A. Note that, the route computation apparatus 10 may be constituted of a plurality of apparatuses that are physically and/or logically separated. In this case, each of a plurality of the apparatuses can include the above-described hardware configuration.

The bus 5A is a data transmission path along which the processor 1A, the memory 2A, the peripheral circuit 4A, and the input/output interface 3A mutually transmit and receive data. The processor 1A is, for example, an arithmetic processing apparatus such as a CPU and a graphics processing unit (GPU). The memory 2A is, for example, a memory such as a random access memory (RAM) and a read only memory (ROM). The input/output interface 3A includes an interface for acquiring information from an input apparatus, an external apparatus, an external server, an external sensor, a camera, and the like, an interface for outputting information to an output apparatus, an external apparatus, an external server, and the like, and the like. The input apparatus is, for example, a keyboard, a mouse, a microphone, a physical button, a touch panel, and the like. The output apparatus is, for example, a display, a speaker, a printer, a mailer, and the like. The processor 1A can issue a command to each module, and perform an arithmetic operation, based on an arithmetic operation result of each module.

### “Functional Configuration”

Next, a functional configuration of the route computation apparatus 10 according to the second example embodiment is described in detail. FIG. 1 illustrates one example of a functional block diagram of the route computation apparatus 10. As illustrated in FIG. 1, the route computation apparatus 10 includes an acquisition unit 11, a determination unit 12, a trend computation unit 13, a route computation unit 14, and a storage unit 15. Similarly to the first example embodiment, the route computation apparatus 10 may not include the storage unit 15. In this case, an external apparatus configured to be communicable with the route computation apparatus 10 includes the storage unit 15.

The route computation apparatus 10 performs a data preparation process of preparing data necessary for route computation, and a route computation process of computing a route, based on the data prepared in the preparation process. Hereinafter, details are described.

### —Data Preparation Process—

The data preparation process is performed before the route computation process. The data preparation process is achieved by the acquisition unit 11, the determination unit 12, and the trend computation unit 13.

The acquisition unit 11 acquires an image photographed by a camera installed at each of a plurality of observation points on a passageway. The image includes at least one of a moving image and a still image. The camera is, for example, a surveillance camera. The camera may photograph a moving image, or photograph a still image at predetermined timing (such as timing that a person is detected within a photographing area). The camera is installed at a position and in an orientation for photographing a passerby passing the passageway.

A way of defining an observation point is not specifically limited. Setting a camera at more observation points, and computing a trend of an attribute of a passerby at the more observation points enables to accurately compute a traffic route suitable for a passerby with a predetermined attribute.

The acquisition unit 11 acquires images for a certain period of time (e.g., for several months, for one year, or for several years) photographed within the certain period of time. The acquisition unit 11 may acquire images for a certain period of time altogether, or may successively acquire at each time of photographing.

The route computation apparatus 10 may be configured to be communicable with a camera. Then, the acquisition unit 11 may acquire an image transmitted from the camera. In addition, an image photographed by the camera may be accumulated in any storage apparatus. Then, the acquisition unit 11 may acquire the image accumulated in the storage apparatus by any means.

In the example embodiment, “acquisition” includes at least one of fetching data or information stored in another apparatus or a storage medium by an own apparatus (active acquisition), and inputting data or information being output from another apparatus to an own apparatus (passive acquisition). Examples of active acquisition include requesting or inquiring another apparatus and receiving a reply thereof, accessing to another apparatus or a storage medium and reading, and the like. Further, examples of passive acquisition include receiving information being distributed (or transmitted, push notified, or the like), and the like. Furthermore, “acquisition” may include selecting and acquiring from received data or information, or selecting and receiving distributed data or information.

The determination unit 12 determines an attribute of a passerby included in an image acquired by the acquisition unit 12. An attribute of a passerby to be determined may affect selection of a traffic route. For example, an attribute of a passerby includes at least one of gender, an age group, physical build, a content of belongings, a transportation means, and presence or absence of a companion.

The age group may be regularly classified at a predetermined interval, such as younger than 10 years old, teens, twenties, and thirties. In addition, the age group may be classified together according to ages of people whose traffic route is assumed to be similar. As this example, younger than 13 years old, age 14 and over but younger than 18 years old, age 18 and over but younger than 40 years old, age 40 and over but younger than 65 years old, age 65 and over, and the like are exemplified, taking into consideration of, for example, physical strength, but the age group is not limited thereto.

Physical build can be identified by image analysis, and is defined in such a way as to include classification that may affect selection of a traffic route. For example, physical build may be defined in such a way as to include skinny build, ordinary build, heavy build, and the like.

A content of belongings to be determined can be identified by image analysis, and includes an element that may affect selection of a traffic route. For example, as a content of belongings, at least some of a clothing style (casual or formal), a clothing type (such as jeans, a short skirt, or a long shirt), a type of shoes (such as sandals, sneakers, boots, high heels, or business shoes), an accessory (such as a hat, sunglasses, or a headphone set), and an object carried by a hand (such as an umbrella, a bag, a suitcase, a stroller, a crutch, or a white cane) may be determined.

A transportation means can be identified by image analysis, and is defined in such a way as to include classification that may affect selection of a traffic route. For example, a transportation means may be defined in such a way as to include walking, running, riding on a bicycle, using a stroller, using a wheelchair, using a white cane, using a crutch, and the like.

Presence or absence of a companion may be determined based on a distance to another person, a time duration that a state in which the distance is equal to or less than a threshold value is maintained, or the like. For example, a person whose state in which a distance to a certain person is equal to or less than a threshold value is maintained for a predetermined time or longer may be determined as a companion of the certain person. Note that, an algorithm for determining presence or absence of a companion by image analysis is not limited thereto.

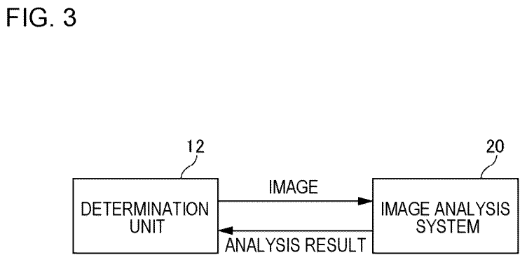

The determination unit 12 determines an attribute of a passerby included in an image, based on a result of analyzing the image. Image analysis is performed by an image analysis system 20 prepared in advance. As illustrated in FIG. 3, the determination unit 12 inputs an image to the image analysis system 20. Then, the determination unit 12 acquires an analysis result on the image from the image analysis system 20. The image analysis system 20 may be a part of the route computation apparatus 10, or may be an external apparatus physically and/or logically independent of the route computation apparatus 10.

Herein, the image analysis system 20 is described. The image analysis system 20 includes at least one of a face recognition function, a human type recognition function, a pose recognition function, a motion recognition function, an external appearance attribute recognition function, an image gradient feature detection function, an image color feature detection function, an object recognition function, a character recognition function, and a gaze detection function.

In the face recognition function, a face feature value of a person is extracted. Further, similarity between face feature values may be collated and computed (such as determination as to whether persons are identical to each other). Further, collation between an extracted face feature value, and a face feature value of a person registered in advance in a database may be made, and determination may be made as to whether a person captured in an image is a person registered in the database.

In the human type recognition function, a human feature value (indicating an overall feature such as, for example, physical build, a height, and clothing) of a person is extracted. Further, similarity between human feature values (such as determination as to whether persons are identical to each other) may be collated and computed. Further, collation between an extracted human feature value, and a human feature value of a person registered in advance in a database may be made, and determination may be made as to whether a person captured in an image is a person registered in the database.

In the pose recognition function and the motion recognition function, articulation points of a person are detected, and a stick figure model is made by connecting the articulation points. Then, based on the stick figure model, a person is detected, a height of a person is estimated, or a feature value of a pose is extracted, or a motion is determined based on a change in a pose. For example, a pose or a motion of a person traveling by each of the above-described transportation means is defined in advance, and these poses or motions are detected. Furthermore, similarity between feature values of a pose or between feature values of a motion may be collated and computed (such as determination as to whether the pose or the motion is the same pose or the same motion). Further, collation between an estimated height, and a height of a person registered in advance in a database may be made, and determination may be made as to whether a person captured in an image is a person registered in the database. The pose recognition function and the motion recognition function may be achieved by the techniques disclosed in the above-described Patent Document 1 and Non-Patent Document 1.

In the external appearance recognition function, an external appearance attribute (e.g., a clothing style, a clothing type, a type of shoes, an accessory, an object carried by a hand, and the like) attached to a person is recognized. For example, a content of the above-described belongings to be determined is defined in advance, and these belongings are detected by image analysis. Further, similarity between recognized external appearance attributes may be collated and computed (determination as to whether the attribute is the same attribute can be made). Furthermore, collation between a recognized external appearance attribute, and an external appearance attribute of a person registered in advance in a database may be made, and determination may be made as to whether a person captured in an image is a person registered in the database.

The image gradient feature detection function is SIFT, SURF, RIFF, ORB, BRISK, CARD, HOG, and the like. According to the function, a gradient feature of each frame image is detected.

In the image color feature detection function, data indicating a feature of a color of an image, for example, such as a color histogram are generated. According to the function, a color feature of each frame image is detected.

The object recognition function is achieved, for example, by using an engine of YOLO (capable of extracting a general object [e.g., a tool, a facility, or the like to be used in sports or other performance], or capable of extracting a person), or the like. Using the object recognition function enables to detect various objects defined in advance from an image. Specifically, an object related to the above-described belongings or transportation means may be defined in advance, and these may be detected.

In the character recognition function, a numeral, a character, and the like are recognized.

In the gaze detection function, a gaze direction of a person captured in an image is detected.

Referring back to FIG. 1, the trend computation unit 13 computes, based on an attribute determination result by the determination unit 12, a trend of an attribute of a passerby passing each of a plurality of observation points.

The trend computation unit 13 determines an attribute of a passerby frequently passing the observation point, for each observation point. For example, the trend computation unit 13 may determine, as an attribute of a passerby frequently passing the observation point, an attribute of a passerby passing the observation point at least once during a predetermined period of time.

In addition, the trend computation unit 13 may determine, as an attribute of a passerby frequently passing the observation point, an attribute of a passerby passing the observation point a reference number of times or more during a predetermined period of time. Note that, an absolute number of passersby with each attribute is different from each other. For example, the number of wheelchair users or white cane users is dominantly small, as compared with the number of pedestrians. In view of the above, the above-described reference number of times may differ for each attribute. Specifically, in a case of a wheelchair user, it may be determined that the wheelchair user frequently passes the observation point in a case where the wheelchair user passes the observation point a first reference number of times (e.g.: five times) or more during a predetermined period of time, and in a case of a pedestrian, it may be determined that the pedestrian frequently passes the observation point in a case where the pedestrian passes the observation point a second reference number of times (e.g.: one hundred times) or more during the predetermined period of time. Further, a traffic amount differs for each observation point. In view of the above, the above-described reference number of times may differ for each observation point.

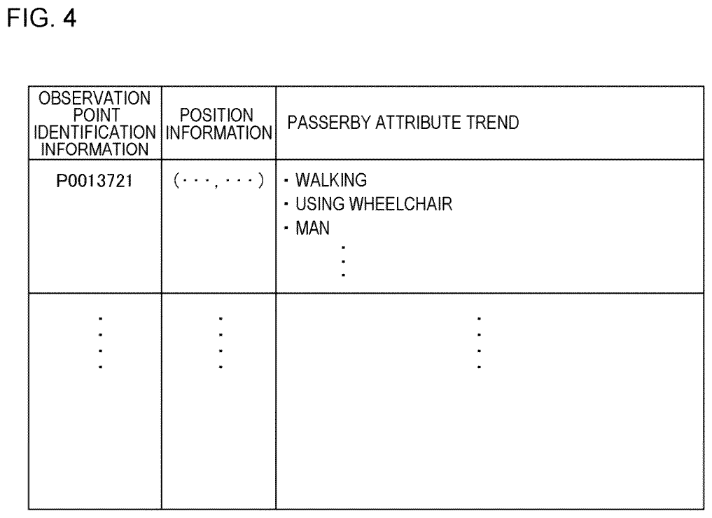

The trend computation unit 13 causes the storage unit 15 to store a computation result. FIG. 4 schematically illustrates one example of a computation result stored in the storage unit 15. In FIG. 4, observation point recognition information, position information, and a passerby attribute trend are associated with one another.

Observation point recognition information is information for identifying a plurality of observation points with one another.

Position information indicates a position of each of a plurality of observation points. As position information, for example, latitude/longitude information, an address, and the like are exemplified.

A passerby attribute trend indicates a computation result of the trend computation unit 13. Specifically, a passerby attribute trend indicates an attribute of a passerby who is determined to frequently pass each of a plurality of observation points.

### —Route Computation Process—

The route computation process is achieved after the data preparation process. The route computation process is achieved by the route computation unit 14.

The route computation unit 14 computes, based on a trend of an attribute of a passerby passing each of a plurality of observation points computed by the trend computation unit 13, a traffic route suitable for a passerby with a predetermined attribute.

The predetermined attribute may be able to be specified by the user each time a search is made. Specifically, the route computation unit 14 may accept a user input of specifying an attribute, each time a search is made. Then, the route computation unit 14 may compute a traffic route suitable for a passerby with an attribute specified by the user input.

In addition, the predetermined attribute may be specified by default in advance. Then, the route computation unit 14 may compute a traffic route suitable for a passerby with an attribute specified by default in advance. In this case, a plurality of patterns may be specified by default in advance. Specifically, a first attribute may be specified as a first pattern, and a second attribute may be specified as a second pattern. In this case, the route computation unit 14 computes a traffic route suitable for a passerby with an attribute specified by each pattern, for each pattern. Note that, a default value may be able to be edited (changed, added, deleted, or the like) by the user.

Further, as an attribute of a passerby with a predetermined attribute, one attribute (example: man) may be specified, or a plurality of attributes (example: man, forties, walking) may be specified. In a case where a plurality of attributes are specified, the route computation unit 14 may compute a traffic route suitable for a passerby with all of a plurality of the specified attributes. In this case, for example, in a case where “man”, “forties”, and “walking” are specified as attributes, the route computation unit 14 computes a traffic route suitable for a man of forties traveling on foot.

In addition, in a case where a plurality of attributes are specified, the route computation unit 14 may compute a traffic route suitable for each of a plurality of passersby with each of a plurality of the specified attributes. In this case, for example, in a case where “man”, “forties”, and “walking” are specified as attributes, the route computation unit 14 computes a traffic route suitable for a man, a traffic route suitable for a passerby of forties, and a traffic route suitable for a passerby traveling on foot.

The route computation unit 14 computes, as a traffic route suitable for a passerby with a predetermined attribute, a traffic route passing an observation point where the passerby with the attribute frequently passes, and not passing an observation point where the passerby with the attribute seldom passes.

An observation point where a passerby with the attribute frequently passes, and an observation point where the passerby with the attribute seldom passes are determined based on a trend (see FIG. 4) of an attribute of a passerby passing each of a plurality of observation points computed by the trend computation unit 13. An observation point where a passerby with a certain attribute frequently passes is an observation point where the attribute is registered in a field of a passerby attribute trend. An observation point where a passerby with a certain attribute seldom passes is an observation point where the attribute is not registered in the field of the passerby attribute trend.

There are various algorithms for computing a traffic route passing an observation point where a passerby with the attribute frequently passes, and not passing an observation point where the passerby with the attribute seldom passes, and any method can be adopted. For example, the route computation unit 14 may define, as a non-passable point, an observation point where a passerby with the attribute seldom passes. Then, the route computation unit 14 may compute a route from a start point specified by the user to a goal point specified by the user by any conventional algorithm in a condition that the route does not pass a non-passable point.

Further, in a case where a plurality of traffic routes (such as traffic routes of a predetermined number M₁ in ascending order of a distance) are computed by the above-described method, the route computation unit 14 may evaluate each of a plurality of the traffic routes, based on a degree with which the route includes an observation point where a passerby with the attribute frequently passes. In this case, each of a plurality of the traffic routes is evaluated by a method in which an evaluation value increases, as a traffic route includes a large number of observation points where a passerby with the attribute frequently passes. Then, the route computation unit 14 may compute, as a traffic route suitable for a passerby with the attribute, traffic routes of a predetermined number M₂ (M₁>M₂) in descending order of an evaluation value.

The route computation apparatus 10 outputs a computation result computed by the route computation unit 14. For example, the route computation apparatus 10 may be a server. Then, the route computation apparatus 10 may transmit the computation result to a client terminal. As the client terminal, a smartphone, a smartwatch, a tablet terminal, a mobile phone, a person computer, and the like are exemplified, but the client terminal is not limited thereto.

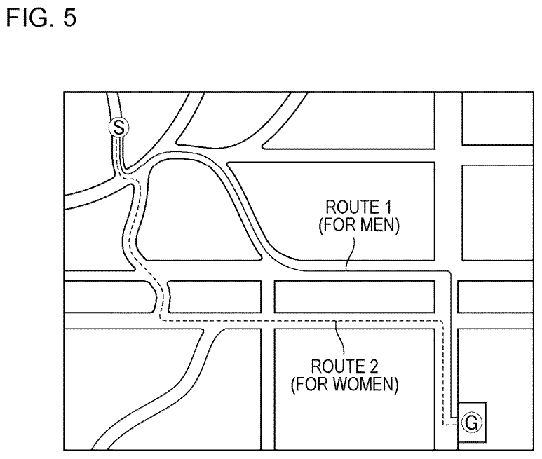

FIG. 5 illustrates one example of a computation result output by the route computation apparatus 10. In the illustrated example, a traffic route suitable for a passerby being a man, and a traffic route suitable for a passerby being a woman are displayed. “S” mark in FIG. 5 is a start point, and “G” mark is a goal point.

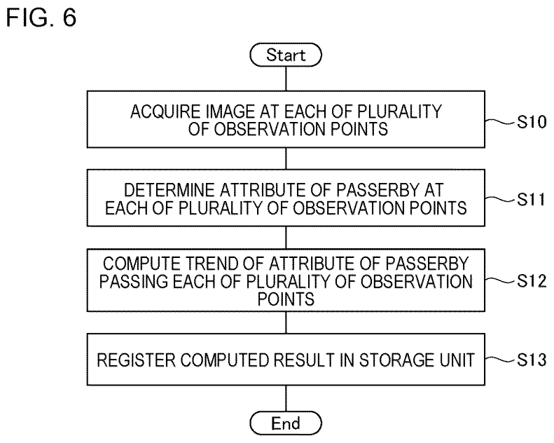

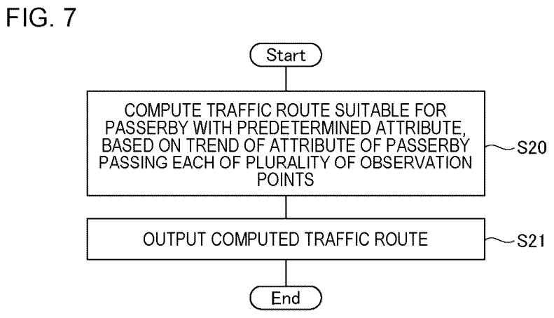

Next, one example of a flow of processing of the route computation apparatus 10 is described by using flowcharts in FIGS. 6 and 7.

FIG. 6 illustrates one example of a flow of processing of the data preparation process. After the route computation apparatus 10 acquires images for a certain period of time photographed by a camera installed at each of a plurality of observation points on a passageway during the certain period of time (S10), the route computation apparatus 10 determines an attribute of a passerby at each of a plurality of the observation points by determining an attribute of a passerby included in the image (S11). Subsequently, the route computation apparatus 10 computes, based on the determination result in S11, a trend of an attribute of a passerby passing each of a plurality of the observation points (S12), and registers the computation result in the storage unit 15 (S13).

FIG. 7 illustrates one example of a flow of processing of the route computation process. The route computation apparatus 10 computes, based on a trend of a passerby passing each of a plurality of the observation points generated in the data preparation process, a traffic route suitable for a passerby with a predetermined attribute (S20). Then, the route computation apparatus 10 outputs the computed traffic route (S21).

### Advantageous Effect

The route computation apparatus 10 according to the second example embodiment analyzes an image photographed by a camera installed at each of a plurality of observation points on a passageway, and computes a trend of an attribute of a passerby passing each of a plurality of the observation points. Then, the route computation apparatus 10 computes, as a traffic route suitable for a passerby with each attribute, a traffic route including a point where a passerby with each attribute frequently passes, and not including a point where the passerby with each attribute does not pass or seldom passes.

According to the route computation apparatus 10 as described above, it becomes possible to compute a traffic route suitable for a person with various attributes.

Further, in a case where a barrier (such as a step, stairs, and an unpaved road) that may affect selection of a traffic route is present, determination as to whether a passerby with each attribute passes the barrier is affected by a circumstance in an area with the barrier, specifically, by presence or absence of a detour around the barrier, a condition of the barrier, and the like. In a case of a technique in which a circumstance of each area is not reflected, and a traffic route in which a barrier is uniformly avoided is computed, a result lacking practicality may be generated such as, for example, computing an extremely long traffic route, or the like.

As exemplified by the route computation apparatus 10, computing a trend of an attribute of a passerby passing each observation point, based on an actual traffic record in a past in each area, and computing a traffic route suitable for a passerby with a predetermined attribute, based on the computation result enables to compute an optimum traffic route reflecting a circumstance in the area.

Further, the route computation apparatus 10 can handle, as an attribute of a passerby, at least one of gender, an age group, physical build, a content of belongings, a transportation means, and presence or absence of a companion. Consequently, according to the route computation apparatus 10, it is possible to classify a passerby, based on various attributes that may affect selection of a traffic route as described above, and compute a traffic route suitable for each passerby.

### Third Example Embodiment

A route computation apparatus 10 according to a third example embodiment computes a trend of an attribute of a passerby passing each of a plurality of observation points, in a case where each of a plurality of conditions defined based on a time period, the day of week, a month, weather, a season, and the like is satisfied. Then, the route computation apparatus 10 computes a traffic route suitable for a passerby with a predetermined attribute in a predetermined condition. Hereinafter, details are described.

A determination unit 12 determines a characteristic of timing that each of images acquired by an acquisition unit 11 is photographed. A characteristic may affect selection of a traffic route, and, for example, may include at least one of a time period, the day of week, a month, weather, and a season. A photographing date and time, the day of week, weather, and the like may be recorded in image metadata. Then, the determination unit 12 may determine the above-described characteristic, based on the image metadata. In addition, after determining a photographing date and time by any means, the determination unit 12 may access to a server in which weather in a past is accumulated, and acquire weather of the photographing date and time. Further, the determination unit 12 may determine a season of a photographed date and time, based on information indicating a correlation between a date registered in the route computation apparatus 10 in advance, and a season.

A trend computation unit 13 computes a trend of an attribute of a passerby passing each of a plurality of observation points, in a case where each of a plurality of conditions defined by the above-described characteristic is satisfied. The condition may be defined by using one characteristic, or may be defined by using a plurality of characteristics. As one example of the condition, “rainy”, “rainy, and from 20:00 to 6:00”, and the like are exemplified, but the condition is not limited thereto.

The trend computation unit 13 determines, based on a characteristic of timing that each of a plurality of images is photographed, a condition in which timing that each of a plurality of the images is photographed is satisfied. Then, the trend computation unit 13 computes, based on an image at a timing that each condition is satisfied, a trend of an attribute of a passerby passing each of a plurality of observation points at a timing where each condition is satisfied. A trend computation method is as described in the second example embodiment.

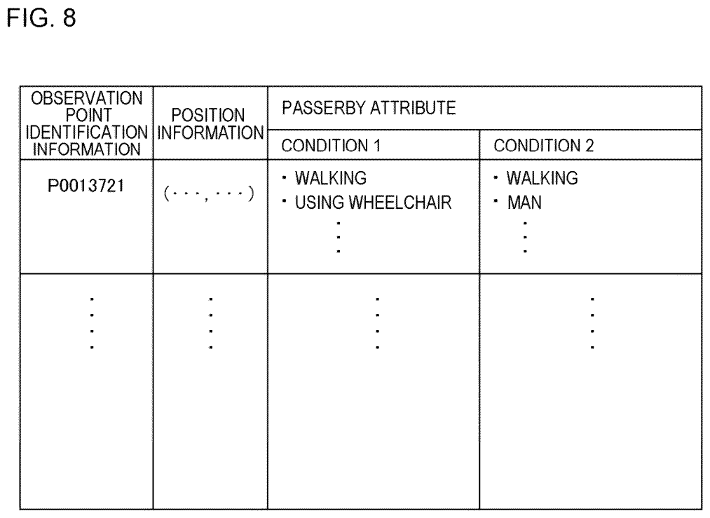

FIG. 8 schematically illustrates one example of a computation result computed by the trend computation unit 13, and stored in a storage unit 15. In FIG. 8, observation point identification information, position information, and a passerby attribute trend are associated with one another. The passerby attribute trend indicates a trend of an attribute of a passerby passing each of a plurality of observation points, at a timing that each condition is satisfied, for each condition.

A route computation unit 14 computes a traffic route suitable for a passerby with a predetermined attribute in a predetermined condition.

The predetermined condition may be able to be specified by the user, each time a search is made. Specifically, the route computation unit 14 may accept a user input of specifying a condition, each time a search is made. Then, the route computation unit 14 may compute a traffic route suitable for a passerby with a predetermined attribute in a condition specified by the user input. Further, the route computation unit 14 may accept a user input of specifying an attribute and a condition, each time a search is made. Then, the route computation unit 14 may compute a traffic route suitable for a passerby with the attribute specified by the user input in the condition specified by the user input.

In addition, the predetermined condition may be specified by default in advance. Then, the route computation unit 14 may compute a traffic route suitable for a passerby with a predetermined attribute in the condition specified by default in advance. In this case, a plurality of patterns may be specified by default in advance. Specifically, a first condition may be specified as a first pattern, and a second condition may be specified as a second pattern. In this case, the route computation unit 14 computes a traffic route suitable for a passerby with a predetermined attribute in a condition of each pattern, for each pattern. Note that, a default value may be able to be edited (changed, added, deleted, or the like) by the user.

The predetermined attribute is specified by the method described in the second example embodiment.

The route computation unit 14 computes, as a traffic route suitable for a passerby with a predetermined attribute in a predetermined condition, a traffic route passing an observation point where a passerby with the attribute frequently passes in a predetermined condition, and not passing an observation point where a passerby with the attribute seldom passes in a predetermined condition.

An observation point where a passerby with the attribute frequently passes in a predetermined condition, and an observation point where a passerby with the attribute seldom passes in a predetermined condition are determined based on a trend (see FIG. 8) of an attribute of a passerby passing each of a plurality of observation points, at a timing that each of a plurality of conditions computed by the trend computation unit 13 is satisfied. For example, an observation point where a passerby with a certain attribute frequently passes at a timing that condition 1 is satisfied is an observation point where the attribute is registered in a field of the condition 1 in a field of a passerby attribute trend. An observation point where a passerby with a certain attribute seldom passes at a timing that the condition 1 is satisfied is an observation point where the attribute is not registered in the field of the condition 1 in the field of the passerby attribute trend.

Computation of a traffic route passing an observation point where a passerby with the attribute frequently passes in a predetermined condition, and not passing an observation point where a passerby with the attribute seldom passes in a predetermined condition is achieved by a method similar to the method described in the second example embodiment.

Other configurations of the route computation apparatus 10 according to the third example embodiment are similar to the configurations of the route computation apparatus 10 according to the first and second example embodiments.

In the route computation apparatus 10 according to the third example embodiment, an advantageous effect similar to that of the route computation apparatus 10 according to the first and second example embodiment is achieved. Further, a characteristic such as a time period, the day of week, a month, weather, and a season may affect selection of a traffic route. For example, there is a passageway that is seldom used in a nighttime, but is frequently used during daylight hours like morning or daytime. Further, there is a passageway that is frequently used on a sunny day, but is seldom used due to utilization such as muddy conditions on a rainy day.

According to the route computation apparatus 10 in which a trend of an attribute of a passerby passing each observation point is computed for each condition defined based on a characteristic as described above, and a traffic route suitable for a passerby with a predetermined attribute in a predetermined condition is computed based on the computation result, it is possible to compute a traffic route more suitable for each passerby.

### Fourth Example Embodiment

A route computation apparatus 10 according to a fourth example embodiment includes a function of causing an output apparatus installed on a passageway to output predetermined information based on a computation result on a trend of an attribute of a passerby passing an observation point on each passageway. Hereinafter, details are described.

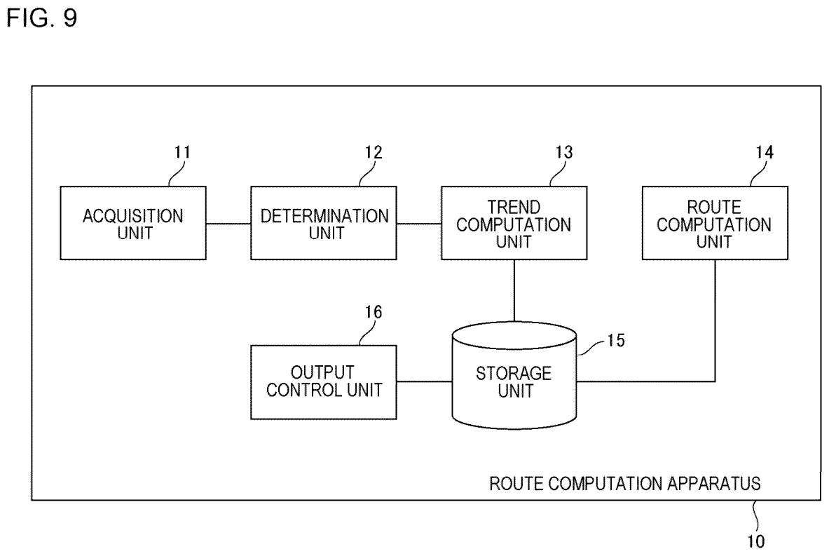

FIG. 9 illustrates one example of a functional block diagram of the route computation apparatus 10 according to the fourth example embodiment. As illustrated in FIG. 9, the route computation apparatus 10 is different from the route computation apparatus 10 according to the first to third example embodiments in a point that the route computation apparatus 10 includes an output control unit 16.

The output control unit 16 causes an output apparatus installed on a passageway to output information indicating whether passing an installed point is suitable for passing of a passerby with a predetermined attribute. A passerby with an attribute suitable for passing the point is a passerby with an attribute that the passerby frequently passes the point. A passerby with an attribute that is not suitable for passing the point is a passerby with an attribute that the passerby seldom passes the point. As described in the second and third example embodiments, a passerby with an attribute that the passerby frequently passes the point, and a passerby with an attribute that the passerby seldom passes the point are determined based on a result of computation (see FIGS. 4 and 8) by the trend computation unit 13.

As the output apparatus, digital signage, a display, a signboard on which a display content can be switched by computer control, a speaker, and the like are exemplified. Information indicating an installation position of each of a plurality of output apparatuses is registered in advance in the route computation apparatus 10. The route computation apparatus 10 determines an observation point near an installation position of each of a plurality of the output apparatuses, based on the information, and position information of each of a plurality of observation points, and causes each of a plurality of the output apparatuses to output predetermined information based on a computation result on a trend of an attribute of a passerby passing the determined observation point.

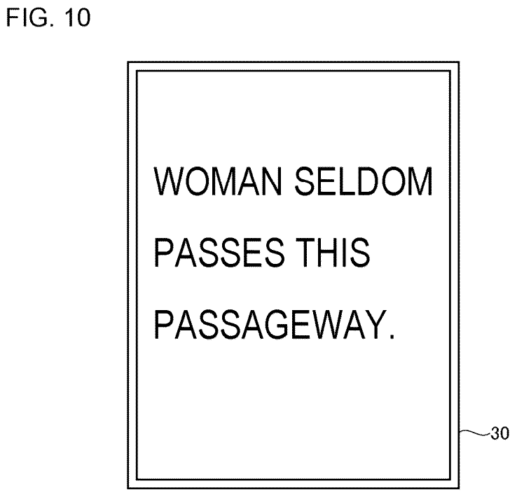

The output control unit 16 may cause each output apparatus to output information such as “A man, a woman, and a pedestrian frequently pass this passageway.”, “A woman seldom passes this passageway.”, or “A woman seldom passes this passageway during a time period from 19:00 to 05:00.”. FIG. 10 illustrates one example of a manner in which information is caused to be output by an output apparatus 30 being a display or digital signage.

As another example, the output control unit 16 may determine a condition being satisfied by a current time (timing that display is controlled). The condition is as described in the third example embodiment, and is defined by a characteristic including at least one of a time period, the day of week, a month, weather, and a season. The output control unit 16 may acquire, from an external server, information indicating a characteristic of a current time, or acquire information indicating a characteristic of a current time, based on a clock function or a calendar function included in the route computation apparatus 10. Then, the output control unit 16 may cause to output information indicating whether passing a point where an output apparatus is installed is suitable for passing of a passerby with a predetermined attribute in a condition being satisfied by a current time. As an example of the information, “Passing this passageway is not suitable for a woman during a current time period.” and the like are exemplified.

Note that, in a case where an attribute of a passerby has a wide variety, the amount of information indicating whether passing an installed point is suitable for passing of a passerby with a predetermined attribute becomes enormous. In view of the above, the output control unit 16 may include the following means for narrowing down information to be output.

For example, the output control unit 16 may acquire an image generated by a camera for photographing a vicinity of an output apparatus by real-time processing, and determine an attribute (hereinafter, a “first attribute”) of a passerby being present at the time at a point where the output apparatus is installed by analyzing the image. Determination on an attribute of a passerby is achieved by a method similar to the method for the determination unit 12.

Then, the output control unit 16 may cause the output apparatus to output information indicating whether passing the installed point is suitable for passing of a passerby with the first attribute. As an example of the information, “Passing this passageway is not suitable for a woman.”, “Passing this passageway is suitable for a wheelchair user.”, and the like are exemplified.

As another example, the output control unit 16 may determine a condition in which timing of controlling display is satisfied by the above-described method, and determine the first attribute of a passerby being present at the time at a point where an output apparatus is installed. Then, the output control unit 16 may cause the output apparatus to output information indicating whether passing a point whether the output apparatus is installed is suitable for passing of a passerby with the first attribute in a condition being satisfied by the current time. As an example of the information, “Passing this passageway is not suitable for a woman during a current time period.” and the like are exemplified.

As another example, the output control unit 16 may acquire an image generated by a camera for photographing a vicinity of an output apparatus, and determine a passerby with an attribute in which a passing status of a point where the output apparatus is installed satisfies a predetermined condition within a latest predetermined time by analyzing the image. As the predetermined condition, “an attribute that most frequently passes”, and the like are exemplified. Then, the output control unit 16 may cause the output apparatus to output information indicating whether the passageway is suitable for passing of a passerby with the determined attribute. As an example of the information, “Passing this passageway is not suitable for a woman.”, “Passing this passageway is not suitable for a woman during a current time period.” and the like are exemplified.

As another example, the output control unit 16 may switch an attribute that information is displayed for each predetermined time. Specifically, a display content may be switched in such a way that, after information indicating whether passing an installed point is suitable for passing of a passerby with a certain attribute is displayed, information indicating whether passing the installed point is suitable for passing of a passerby with another attribute is displayed, and subsequently, information indicating whether passing the installed point is suitable for passing of a passerby with still another attribute is displayed.

Other configurations of the route computation apparatus 10 according to the fourth example embodiment are similar to the configurations of the route computation apparatus 10 according to the first to third example embodiments.

In the route computation apparatus 10 according to the fourth example embodiment, an advantageous effect similar to that of the route computation apparatus 10 according to the first to fourth example embodiments is achieved. Further, in the route computation apparatus 10 according to the fourth example embodiment, it is possible to cause an output apparatus installed on a passageway to output information indicating whether passing an installed point is suitable for passing of a passerby with a predetermined attribute. Consequently, it becomes possible to give a sense of security to a passerby, give warning to a passerby, or call attention to a passerby.

In the foregoing, example embodiments according to the present invention have been described with reference to the drawings, however, these are examples of the present invention, and various configurations other than the above can also be adopted. The configurations of the above-described example embodiments may be combined with each other, or some configurations may be interchanged with another configuration. Further, various changes may be added to the configuration of the above-described example embodiments within a range that does not depart from the gist of the invention. Further, a configuration and processing disclosed in the above-described each example embodiment and modification example may be combined with each other.

Further, in a flowchart used in the above description, a plurality of processes (pieces of processing) are described in order, however, an order of execution of processes to be performed in each example embodiment is not limited to the order of description. In each example embodiment, the illustrated order of processes can be changed within a range that does not adversely affect a content. Further, the above-described example embodiments can be combined, as far as contents do not conflict with each other.

A part or all of the above-described example embodiments may also be described as the following supplementary notes, but is not limited to the following.

1. A route computation apparatus including:
an acquisition unit that acquires an image photographed by a camera installed at each of a plurality of observation points on a passageway;
a determination unit that determines an attribute of a passerby included in the image;
a trend computation unit that computes, based on a determination result on the attribute, a trend of an attribute of a passerby passing each of a plurality of the observation points; and
a route computation unit that computes, based on the trend, a traffic route suitable for a passerby with the predetermined attribute.
   2. The route computation apparatus according to supplementary note 1, wherein
the route computation unit
   accepts a user input of specifying the attribute, and
   computes a traffic route suitable for a passerby with the attribute specified by the user input.
      3. The route computation apparatus according to supplementary note 1 or 2, wherein the attribute includes at least one of gender, an age group, physical build, a content of belongings, transportation means, and presence or absence of a companion.
      4. The route computation apparatus according to any one of supplementary notes 1 to 3, wherein
the determination unit further determines a characteristic of timing that the image is photographed,
the trend computation unit computes a trend of an attribute of a passerby passing each of a plurality of the observation points, in a case where each of a plurality of conditions defined by the characteristic is satisfied, and
the route computation unit computes a traffic route suitable for a passerby with the predetermined attribute in a predetermined condition.
   5. The route computation apparatus according to supplementary note 4, wherein
the route computation unit
   accepts a user input of specifying the attribute and the condition, and
   computes a traffic route suitable for a passerby with the attribute specified by the user input in the condition specified by the user input.
      6. The route computation apparatus according to supplementary note 4 or 5, wherein the characteristic includes at least one of a time period, the day of week, a month, weather, and a season.
      7. The route computation apparatus according to any one of supplementary notes 1 to 6, further including an output control unit that causes an output apparatus installed on the passageway to output information indicating whether passing an installed point is suitable for passing of a passerby with the predetermined attribute.
      8. The route computation apparatus according to supplementary note 7, wherein
the output control unit
   determines, based on an image generated by a camera for photographing a vicinity of the output apparatus, a first attribute being the attribute of a passerby present at the time at a point where the output apparatus is installed, and
   causes the output apparatus to output information indicating whether passing an installed point is suitable for passing of a passerby with the first attribute.
      9. A route computation method including,
by a computer:
   acquiring an image photographed by a camera installed at each of a plurality of observation points on a passageway;
   determining an attribute of a passerby included in the image;
   computing, based on a determination result on the attribute, a trend of an attribute of a passerby passing each of a plurality of the observation points; and
   computing, based on the trend, a traffic route suitable for a passerby with the predetermined attribute.
      10. A storage medium storing a program causing a computer to function as:
an acquisition unit that acquires an image photographed by a camera installed at each of a plurality of observation points on a passageway;
a determination unit that determines an attribute of a passerby included in the image;
a trend computation unit that computes, based on a determination result on the attribute, a trend of an attribute of a passerby passing each of a plurality of the observation points; and
a route computation unit that computes, based on the trend, a traffic route suitable for a passerby with the predetermined attribute.

### REFERENCE SIGNS LIST

10 Route computation apparatus
11 Acquisition unit
12 Determination unit
13 Trend computation unit
14 Route computation unit
15 Storage unit
16 Output control unit
20 Image analysis system
30 Output apparatus
1A Processor
2A Memory
3A Input/output I/F
4A Peripheral circuit
5A Bus

What is claimed is:

1. A route computation apparatus comprising:
at least one memory configured to store one or more instructions; and
at least one processor configured to execute the one or more instructions to:
acquire an image photographed by a camera installed at each of a plurality of observation points on a passageway;
determine an attribute of a passerby included in the image;
compute, based on a determination result on the attribute, a trend of an attribute of a passerby passing each of a plurality of the observation points; and
compute, based on the trend, a traffic route suitable for a passerby with the predetermined attribute.

2. The route computation apparatus according to claim 1, wherein
the at least one processor is further configured to execute the one or more instructions to
accept a user input of specifying the attribute, and
compute a traffic route suitable for a passerby with the attribute specified by the user input.

3. The route computation apparatus according to claim 1, wherein
the attribute includes at least one of gender, an age group, physical build, a content of belongings, transportation means, and presence or absence of a companion.

4. The route computation apparatus according to claim 1, wherein the at least one processor is further configured to execute the one or more instructions to
determine a characteristic of timing that the image is photographed,
compute a trend of an attribute of a passerby passing each of a plurality of the observation points, in a case where each of a plurality of conditions defined by the characteristic is satisfied, and
compute a traffic route suitable for a passerby with the predetermined attribute in a predetermined condition.

5. The route computation apparatus according to claim 4, wherein
the at least one processor is further configured to execute the one or more instructions to
accept a user input of specifying the attribute and the condition, and
compute a traffic route suitable for a passerby with the attribute specified by the user input in the condition specified by the user input.

6. The route computation apparatus according to claim 4, wherein
the characteristic includes at least one of a time period, the day of week, a month, weather, and a season.

7. The route computation apparatus according to claim 1, wherein the at least one processor is further configured to execute the one or more instructions to
cause an output apparatus installed on the passageway to output information indicating whether passing an installed point is suitable for passing of a passerby with the predetermined attribute.

8. The route computation apparatus according to claim 7, wherein
the at least one processor is further configured to execute the one or more instructions to
determine, based on an image generated by a camera for photographing a vicinity of the output apparatus, a first attribute being the attribute of a passerby present at the time at a point where the output apparatus is installed, and
cause the output apparatus to output information indicating whether passing an installed point is suitable for passing of a passerby with the first attribute.

9. A route computation method comprising:
acquiring an image photographed by a camera installed at each of a plurality of observation points on a passageway;
determining an attribute of a passerby included in the image;
computing, based on a determination result on the attribute, a trend of an attribute of a passerby passing each of a plurality of the observation points; and
computing, based on the trend, a traffic route suitable for a passerby with the predetermined attribute.

10. A non-transitory storage medium storing a program causing a computer to:
acquire an image photographed by a camera installed at each of a plurality of observation points on a passageway;
determine an attribute of a passerby included in the image;
compute, based on a determination result on the attribute, a trend of an attribute of a passerby passing each of a plurality of the observation points; and
compute, based on the trend, a traffic route suitable for a passerby with the predetermined attribute.

11. The route computation method according to claim 9, further comprising:
accepting a user input of specifying the attribute; and
computing a traffic route suitable for a passerby with the attribute specified by the user input.

12. The route computation method according to claim 9, wherein
the attribute includes at least one of gender, an age group, physical build, a content of belongings, transportation means, and presence or absence of a companion.

13. The route computation method according to claim 9, further comprising:
determining a characteristic of timing that the image is photographed,
computing a trend of an attribute of a passerby passing each of a plurality of the observation points, in a case where each of a plurality of conditions defined by the characteristic is satisfied, and
computing a traffic route suitable for a passerby with the predetermined attribute in a predetermined condition.

14. The route computation method according to claim 13, further comprising:
accepting a user input of specifying the attribute and the condition; and
computing a traffic route suitable for a passerby with the attribute specified by the user input in the condition specified by the user input.

15. The route computation method according to claim 13, wherein
the characteristic includes at least one of a time period, the day of week, a month, weather, and a season.

16. The non-transitory storage medium according to claim 10, wherein
the program causing the computer to
accept a user input of specifying the attribute, and
compute a traffic route suitable for a passerby with the attribute specified by the user input.

17. The non-transitory storage medium according to claim 10, wherein
the attribute includes at least one of gender, an age group, physical build, a content of belongings, transportation means, and presence or absence of a companion.

18. The non-transitory storage medium according to claim 10, wherein the program causing the computer to
determine a characteristic of timing that the image is photographed,
compute a trend of an attribute of a passerby passing each of a plurality of the observation points, in a case where each of a plurality of conditions defined by the characteristic is satisfied, and
compute a traffic route suitable for a passerby with the predetermined attribute in a predetermined condition.

19. The non-transitory storage medium according to claim 18, wherein
the program causing the computer to
accept a user input of specifying the attribute and the condition, and
compute a traffic route suitable for a passerby with the attribute specified by the user input in the condition specified by the user input.

20. The non-transitory storage medium according to claim 18, wherein
the characteristic includes at least one of a time period, the day of week, a month, weather, and a season.
